(19) United States
(12) Patent Application Publication
(10) Pub. No.: US 2009/0291342 A1
(43) Pub. Date: Nov. 26, 2009

(54) FUEL CELL SYSTEM

(76) Inventors: Takayoshi Tezuka, Shizuoka-ken (JP); Yoshihito Kanno, Shizuoka-ken (JP); Hideaki Kume, Shizuoka-ken (JP); Hidetoshi Kato, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/293,032

(22) PCT Filed: Mar. 14, 2007
(86) PCT No.: PCT/IB07/00609

§ 371 Date: Sep. 15, 2008

(30) Foreign Application Priority Data
Mar. 16, 2006 (JP) 2006-072422
Jan. 22, 2007 (JP) 2007-010976

(51) Int. Cl. H01M 8/04

(52) U.S. Cl. 429/24; 429/22

(57) ABSTRACT

A fuel cell system includes a fuel cell (1) having a plurality of unit cells (1a) stacked on each other, first and second end plates (1b, 1c) between which the plurality of unit cells are interposed, and a gas supply passage (1d) and a gas discharge passage (1e), both extending in the stacking direction of the unit cells. An inlet (1f) of the gas supply passage (1d) and an outlet (1g) of the gas discharge passage (1e) are located on the first end plate side. A hydrogen concentration sensor (4) is disposed in the gas discharge passage and detects a hydrogen concentration in the gas discharged from the plurality of unit cells. An electricity generation process in the fuel cell is controlled based on the hydrogen concentration detected by a hydrogen concentration sensor (4).

### BACKGROUND OF THE INVENTION

1. Field of the Invention

The invention relates to a fuel cell system that generates electric energy through an electrochemical reaction.

2. Description of the Related Art

The fuel cell system supplies fuel gas, such as hydrogen, and oxidizing gas including oxygen, and generate electric energy via an electrochemical reaction between the fuel gas and the oxidizing gas at an electrolyte membrane. One of such fuel cells includes multiple unit cells stacked on each other. Each unit cell is formed of the electrolyte membrane and an anode and a cathode between which the electrolyte membrane is interposed.

In the fuel cell system, nitrogen gas, and the like, is transmitted from the cathode to the anode when the fuel cell stops. Therefore, hydrogen gas is supplied to the anode to replace the gas in the anode with the hydrogen gas (“hydrogen replacement process”) before the fuel cell is started (for example, in Japanese Patent Application Publication No. 2004-139984). The fuel cell system detects the hydrogen concentration in the off-gas discharged from the fuel cell, and determines whether the hydrogen replacement process is completed based on the detected hydrogen concentration at the start-up of the fuel cell.

According to the above-described fuel cell system, by determining whether the hydrogen replacement process is completed based on the off-gas discharged from the fuel cell, the fuel cell can start generating electricity when the gas in the anode is mostly replaced with hydrogen. However, in the fuel cell in which multiple unit cells are stacked on each other and a hydrogen supply passage extends in the stacking direction of the unit cells, the time when hydrogen is supplied to the unit cell near the inlet of the hydrogen supply passage is different from the time when hydrogen is supplied to the unit cell located most distant from the inlet. While the hydrogen replacement process is not completed in the unit cell located most distant from the inlet, the hydrogen replacement process may be completed in the unit cell near the inlet. Thus, it is difficult to detect, based on the off-gas from the fuel cell, when the hydrogen replacement process is completed in all the unit cells. Accordingly, excessive hydrogen gas may be supplied even after the hydrogen replacement process is completed, or the electricity generation process may start before sufficient hydrogen gas is supplied.

In another fuel cell system, anode off-gas discharged from the fuel cell is recirculated to the fuel cell to reuse the hydrogen included in the anode off-gas in the electricity generation process of the fuel cell (for example, in Japanese Patent Application Publication No. 2004-185974). In the fuel cell system, hydrogen gas discharged to the exterior of the system is reduced. Further, in the other fuel cell system, discharge of anode off-gas is stopped during the electricity generation process in the fuel cell, to use more hydrogen gas supplied to the fuel cell in the electricity generation process, thereby reducing the hydrogen gas discharged from the system.

In these fuel cell systems, because nitrogen gas is transmitted from the cathode side to the anode side via the electrolyte membrane, the nitrogen concentration increases and the hydrogen concentration decreases in the anode side, and thus the generating efficiency also decreases. To resolve such problems, an outlet valve may be provided to discharge the hydrogen gas or anode off-gas for recirculation to the exterior of the system, and the outlet valve may be periodically opened to discharge the nitrogen gas included in the hydrogen gas.

However, if the outlet valve is opened, hydrogen is discharged along with the nitrogen gas. Thus, if the outlet valve is opened more than necessary, the generating efficiency of the fuel cell system decreases. Accordingly, it is desired to discharge nitrogen gas, while reducing the discharge of hydrogen gas. Nevertheless, because the flow of the off-gas slows down in the neighbor of the outlet of the anode off-gas, especially when the discharge of the anode off-gas from the fuel cell is stopped, it is difficult to detect the hydrogen concentration in each unit cell. Accordingly, hydrogen gas is sometimes discharged more than is necessary.

### SUMMARY OF THE INVENTION

The present invention provides a fuel cell system that includes a fuel cell having multiple unit cells stacked on each other. The fuel cell system more accurately detects when the hydrogen replacement process is completed, or when discharge of nitrogen gas is completed, or the like, and thus reduces unnecessary discharge of the hydrogen.

The present invention focuses on the position where the concentration of hydrogen gas is detected. A first aspect of the present invention provides a fuel cell system that includes a fuel cell having a plurality of unit cells stacked on each other; first and second end plates between which the plurality of unit cells are interposed; a gas supply passage, extending in the stacking direction of the plurality of unit cells, that supplies gas to each of the plurality of unit cells, and has an inlet on the first end plate side; and a gas discharge passage through which the gas discharged from the plurality of unit cells flows and has an outlet on the first end plate side. The fuel cell system further includes hydrogen supply means for supplying hydrogen gas to the plurality of unit cells in the fuel cell through the gas supply passage; a hydrogen concentration sensor, disposed in the gas discharge passage, that detects the hydrogen concentration in the gas discharged from the plurality of unit cells; and electricity generation control means for controlling the electricity generation process in the fuel cell based on the hydrogen concentration detected by the hydrogen concentration sensor.

In the fuel cell system according to the first aspect of the present invention, the inlet of the gas supply passage through which the hydrogen gas supplied to the unit cells flows in, and the outlet of the gas discharge passage through which the gas discharged from the unit cells flows out are both located in the first end plate side. A fuel cell stack is formed of multiple stacked cells interposed between the first end plate and the second end plate. Further, the supply of hydrogen to each unit cell forming the fuel cell stack is detected accurately by disposing the hydrogen concentration sensor in the gas discharge passage formed in the stack. Furthermore, the timing control of the fuel cell can be more appropriate, and unnecessary discharge of hydrogen gas is reduced. In addition, because the hydrogen concentration sensor is disposed in the fuel cell stack, the system avoids the situation where hydrogen gas is no longer present around the hydrogen concentration sensor due to the various processes performed in the fuel cell. Therefore, the control of the electricity generation process by the electricity generation control means is less likely to be interrupted.

The hydrogen concentration sensor may be located in the gas discharge passage in the vicinity of the second end plate. By locating the hydrogen concentration sensor at the position, the existence of the hydrogen gas at the bottom of the stacked unit cells can be detected more accurately.

The electricity generation control means starts the electricity generation process when the hydrogen concentration detected by the hydrogen concentration sensor is equal to or higher than a threshold concentration after the hydrogen supply means starts supplying the hydrogen gas to the fuel cell. The fuel cell system may further include an off-gas passage through which the off-gas discharged from the fuel cell via the gas discharge passage flows, and off-gas flow volume adjustment means, disposed in the off-gas passage, for adjusting the flow volume of the off-gas. The electricity generation control means in this case may control the off-gas flow volume adjustment means to adjust the flow volume in accordance with the hydrogen concentration detected by the hydrogen concentration sensor. Note that the off-gas passage is located outside of the fuel cell stack, and is clearly different from the gas discharge passage provided in the fuel cell.

The fuel cell generates electricity when the off-gas flow volume adjustment means prohibits the discharge of off-gas from the fuel cell through the off-gas passage and when the off-gas discharged from the outlet of the gas discharge passage does not recirculate to the fuel cell via the inlet of the gas supply passage. In this case, the electricity generation control means may determine whether the off-gas flow volume adjustment means continues to prohibit discharging the off-gas from the fuel cell or starts discharging the off-gas in accordance with the hydrogen concentration detected by the hydrogen concentration sensor. Because the hydrogen concentration sensor is located in the gas discharge passage, the hydrogen concentration sensor detects the hydrogen gas discharged from the stacked unit cells in the fuel cell, regardless of the flow in the off-gas passage. Accordingly, even if the fuel cell generates electricity when the off-gas is not discharged from the fuel cell as described above, the hydrogen fuel sensor detects the hydrogen gas discharged from the stacked unit cells. Thus, by controlling the discharge of the off-gas based on the detected result, unnecessary discharge of hydrogen gas included in the off-gas to the exterior is reduced.

The electricity generation control means may control the off-gas flow volume adjustment means to increase the discharge flow volume of the off-gas above a reference discharge flow volume, when the hydrogen concentration detected by the hydrogen concentration sensor is equal to or lower than a minimum threshold limit. The minimum threshold limit of the hydrogen concentration is the concentration of hydrogen at or above which the fuel cell generates electricity efficiently. The reference discharge flow volume is a discharge flow volume of off-gas with which the fuel cell generates electricity efficiently. The reference discharge flow volume is not a constant value, and changes depending on various factors, such as the operating condition or ambient environmental condition of the fuel cell. Accordingly, when the hydrogen concentration decreases to the minimum threshold limit or below, the electricity generation control means increases the discharge flow volume of the off-gas, thereby discharging gas other than hydrogen that may have accumulated in the fuel cell and increasing the generating efficiency of the fuel cell again.

Further, the electricity generation control means may control the off-gas flow volume adjustment means to decrease the discharge flow volume of the off-gas below a reference discharge flow volume or prohibits the discharge of the off-gas, when the hydrogen concentration detected by the hydrogen concentration sensor is equal to or higher than a maximum threshold limit. The maximum threshold limit of the hydrogen concentration is the concentration of hydrogen at or above which sufficient hydrogen gas is supplied for the fuel cell to generate electricity and hydrogen gas would be discharged more than is necessary if the off-gas including hydrogen gas continues to be discharged. The reference discharge flow volume is as described above. Accordingly, when the hydrogen concentration increases to the maximum threshold limit or above, the electricity generation control means prevents unnecessary discharge of hydrogen gas by reducing the flow volume of off-gas.

A second aspect of the present invention provides a fuel cell system that includes a fuel cell having a plurality of unit cells stacked on each other, first and second end plates between which the plurality of unit cells are interposed, a gas supply passage, and a gas discharge passage. The gas supply passage extends in the stacking direction of the plurality of unit cells and supplies gas to each of the plurality of unit cells. The inlet of the gas supply passage is provided on the first end plate side. The gas discharged from the plurality of unit cells flows through the gas discharge passage, and the outlet of the gas discharge passage is on the first end plate side. The fuel cell system further includes hydrogen supply means for supplying hydrogen gas to the plurality of unit cells in the fuel cell through the gas supply passage, first hydrogen concentration detection means for detecting the hydrogen concentration in the gas flowing in the gas discharge passage that is discharged from a first unit cell in the plurality of unit cells, and second hydrogen concentration detection means for detecting a hydrogen concentration in gas flowing in the gas supply passage that is supplied to a second unit cell in the plurality of unit cells. The fuel cell system further includes electricity generation control means for controlling an electricity generation process of the fuel cell in accordance with the time interval between a first time point and a second time point. The first time point is when the first hydrogen concentration detection means detects hydrogen, and the second time point is when the second hydrogen concentration detection means detects hydrogen.

According to the second aspect of the present invention, two hydrogen concentration detection means are respectively provided on the gas discharge passage side and the gas supply passage side in the fuel cell stack. The two hydrogen concentration detection means are located near different unit cells. The electricity generation control means performs the electricity generation process of the fuel cell based on the time interval between when the two hydrogen concentration detection means detect hydrogen. Because two hydrogen concentration detection means are provided in the fuel cell stack, the supply of hydrogen gas to the fuel cell is monitored more accurately, regardless of the discharge situation of the off-gas from the fuel cell. In other words, the first time point is related to when hydrogen gas is supplied to the corresponding first unit cell, and the second time point is related to when sufficient hydrogen gas starts to be supplied to the corresponding second unit cell. Accordingly, the time interval between the first time and the second time is a parameter that accurately reflects the supply of hydrogen to the unit cell stacked in the fuel cell.

Accordingly, by controlling the electricity generation process of the fuel cell by the electricity generation control means based on the time interval, it avoids unnecessary discharge of the hydrogen, and facilitates the efficiency of the electricity generation process. Here, the electricity generation process performed by the electricity generation control means may include the above-described control of the time to start generating electricity, control of discharge flow volume of off-gas, or the like.

The second hydrogen detection means may be disposed in the gas supply passage in the vicinity of the first end plate. The first hydrogen detection means may be disposed in the gas discharge passage in the vicinity of the second end plate. By disposing the hydrogen concentration detection means as described above, the supply of hydrogen gas in the fuel cell stack can be monitored more accurately. Further, the second unit cell may be located upstream of the first unit cell with respect to the flow of hydrogen flowing in the gas supply passage. With this arrangement as well, the supply of hydrogen gas can be monitored more accurately.

The first hydrogen concentration detection means and the second hydrogen concentration detection means may respectively detect the hydrogen concentrations with respect to the first and second unit cells in accordance with changes in voltages generated by supplying hydrogen to the first and second unit cells. In this case, the first time point may be when the voltage generated in the first unit cell reaches a predetermined reference voltage, and the second time point may be when the voltage generated in the second unit cell reaches the predetermined reference voltage. The electricity generation control means controls the electricity generation process of the fuel cell in accordance with the time interval between the first time point and the second time point. Accordingly, by using the change in voltage generated by each unit cell, the number of components constituting the fuel cell system is minimized.

A third aspect of the present invention provides a fuel cell system that includes a fuel cell having a plurality of unit cells stacked on each other; first and second end plates between which the plurality of unit cells are interposed; a gas supply passage, extending in a stacking direction of the plurality of unit cells, that supplies gas to the plurality of unit cells. The inlet of the gas supply passage is provided on the first end plate side of the plurality of unit cells. A gas discharge passage, through which gas discharged from the plurality of unit cells flows, is also provided in the fuel cell and has an outlet on the first end plate side. The fuel cell system further includes hydrogen supply device that supplies hydrogen gas to the plurality of unit cells in the fuel cell, a hydrogen concentration sensor, disposed in the gas discharge passage in the vicinity of the second end plate, that detects a hydrogen concentration in the gas discharged from the plurality of unit cells, and a controller that obtains the detected hydrogen concentration from the hydrogen concentration sensor after the hydrogen supply device starts supplying hydrogen, and starts generating electricity in the fuel cell if the detected hydrogen concentration is equal to or higher than a threshold concentration.

In the fuel cell system, the inlet of the gas supply passage, though which hydrogen gas is supplied to the unit cell, and the outlet of the gas discharge passage, through which the gas discharged from the unit cell flows, are provided on the side of the first end plate. Thus, hydrogen gas supplied from the inlet is supplied first to the unit cell in the vicinity of the first end plate. On the other hand, the supply of the hydrogen gas to the unit cell in the vicinity of the second end plate is delayed, relative to the unit cell in the vicinity of the first end plate. At the start-up of the fuel cell, however, it is preferable that the fuel cell starts generating electricity after hydrogen gas is supplied to all the unit cells.

According to the third aspect of the present invention, the hydrogen concentration sensor is located in the gas discharge passage of the unit cell in the vicinity of the second end plate, at which the supply of hydrogen gas is most delayed, and the fuel cell starts generating electricity based on the hydrogen concentration detected by the hydrogen concentration sensor. Accordingly, the electricity generation process starts when the gas in all unit cells is replaced with hydrogen, thereby reducing unnecessary discharge of hydrogen gas.

The threshold concentration is the hydrogen concentration where nitrogen gas is expected to have been discharged to the extent enabling the electricity generation process (the hydrogen replacement process is completed), and may be set appropriately depending on the fuel cell construction or the like.

A fourth aspect of the present invention provides a fuel cell system that includes a fuel cell having a plurality of unit cells stacked on each other; first and second end plates between which the plurality of unit cells are interposed; a gas supply passage, extending in a stacking direction of the plurality of unit cells, that supplies gas to the plurality of unit cells, and has an inlet on the first end plate side; and a gas discharge passage through which the gas discharged from the plurality of unit cells flows and has an outlet on the first end plate side. The fuel cell system further includes a hydrogen concentration sensor, disposed in the gas discharge passage in the vicinity of the second end plate, that detects the hydrogen concentration in the gas discharged from the plurality of unit cells; an off-gas passage through which the gas discharged from the fuel cell via the gas discharge passage flows, an off-gas flow volume adjusting device that is disposed in the off-gas passage and adjusts the flow volume of the off-gas, and a controller that controls a discharge flow volume of the off-gas using the off-gas flow volume adjusting device, based on the hydrogen concentration detected by the hydrogen concentration sensor.

The off-gas flow volume adjusting device is a device that adjusts the flow volume of the off-gas discharged from the fuel cell, and that adjusts the flow volume of the off-gas to discharge the nitrogen gas accumulated in the fuel cell to the exterior of the fuel cell. More specifically, it is applied to the system that stops discharging the off-gas during the electricity generation process of the fuel cell, or a system that recirculate the off-gas to the fuel cell to use in the electricity generation process. The discharge flow volume of the off-gas is adjusted to suppress the discharge of hydrogen gas, while the nitrogen accumulated in the fuel cell is discharged.

In such a fuel cell system, to discharge nitrogen gas accumulated in the fuel cell while suppressing the discharge of the hydrogen gas, it is preferable that the hydrogen concentration in each unit cell is known. However, when the discharge of the off-gas is stopped, it is difficult to detect the hydrogen concentration in the unit cell, because the flow of off-gas slows down near the outlet of the off-gas, i.e., near the first end plate.

According to the fourth aspect of the present invention, however, the hydrogen concentration sensor is provided in the gas discharge passage for the unit cell in the vicinity of the second end plate, where nitrogen gas accumulates, the detected hydrogen concentration in the unit cell also reflects the influence of nitrogen. The off-gas flow volume adjusting device adjusts the discharge flow volume of the off-gas in accordance with the hydrogen concentration detected by the hydrogen concentration sensor. By doing this, an appropriate amount of nitrogen gas accumulated in the fuel cell is discharged, and unnecessary discharge of hydrogen gas is reduced.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a block diagram illustrating a fuel cell system according to a first embodiment of the invention.

FIG. 2 is a schematic view illustrating an example of a fuel cell according to the embodiment.

FIG. 3 is a flowchart illustrating a supply control of hydrogen gas during an electricity generation process of the fuel cell.

FIG. 4 is a flowchart illustrating a control process of the discharge flow volume of anode off-gas during the electricity generation process according to the first embodiment.

FIG. 5 is a flowchart illustrating a control of the flow volume of anode off-gas discharging during the electricity generation process according to a second embodiment.

FIG. 6 is a view illustrating an example of a fuel cell according to a third embodiment of the present invention.

FIG. 7 is a flowchart illustrating an electricity generation control process when the generation of electricity starts in the fuel cell according to the third embodiment.

FIG. 8 is a flowchart illustrating an electricity generation control process when the generation of electricity starts in the fuel cell according to the third embodiment.

### DETAILED DESCRIPTION OF THE PREFERRED EMBODIMENTS

Embodiments of the present invention are described in detail below, with references made to the drawings.

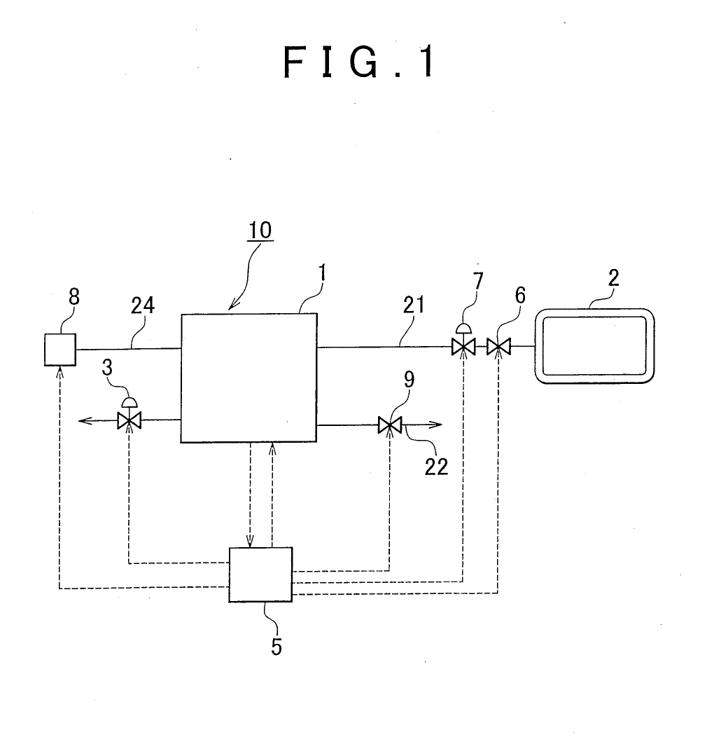

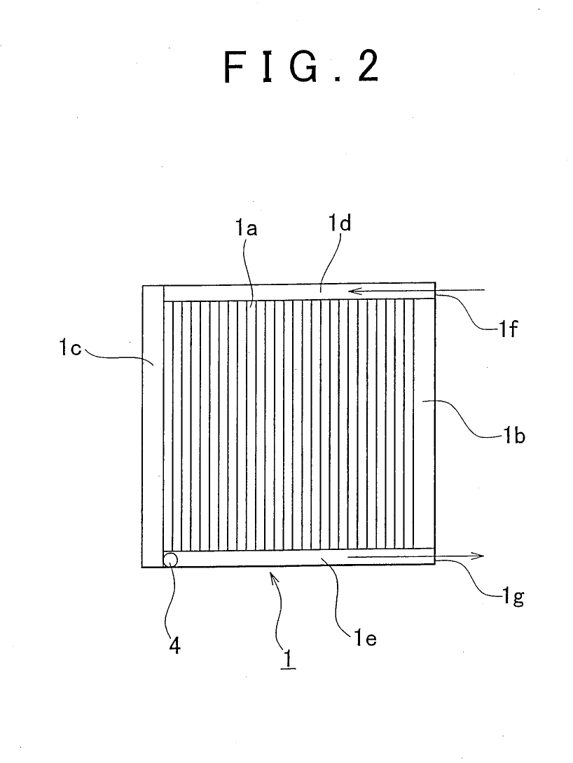

FIG. 1 is a block diagram illustrating a fuel cell system according to a first embodiment of the invention. The fuel cell system 10 includes a fuel cell 1, a high-pressure hydrogen tank 2, an open valve 6 of the high-pressure hydrogen tank 2, a pressure regulator valve 7, an oxidizing gas supply passage 24 through which air is supplied to the fuel cell 1, an air compressor 8, and a hydrogen supply passage 21. The fuel cell 1 generates electricity by the electrochemical reaction between hydrogen gas and oxidizing gas. The high-pressure hydrogen tank 2 stores hydrogen gas, serving as fuel gas, and supplies the hydrogen gas to the fuel cell 1. The high-pressure hydrogen tank 2 functions as a hydrogen supply means. The pressure regulator valve 7 adjusts the pressure of the hydrogen gas discharged from the high-pressure hydrogen tank 2. The air compressor 8 is provided in the oxidizing gas supply passage 24 and supplies oxidizing gas to the fuel cell 1. The hydrogen gas supplied from the high-pressure hydrogen tank 2 to the fuel cell 1 flows through the hydrogen supply passage 21. The fuel cell system 10 further includes an anode off-gas passage 22, a hydrogen concentration sensor 4 (see FIG. 2) provided in the fuel cell 1, an outlet valve 9, a pressure regulator valve 3 for cathode off-gas discharged from the cathode side of the fuel cell 1, and an ECU 5. Anode off-gas discharged from the anode side of the fuel cell 1 flows through the anode off-gas passage 22. The outlet valve 9 is provided in the anode off-gas passage 22 and adjusts the discharge flow volume of the anode off-gas. The outlet valve 9 functions as an off-gas flow volume adjustment means. The ECU 5 performs various control processes of the fuel cell, including control of the supply of the hydrogen gas from the high-pressure hydrogen tank 2.

FIG. 2 is a schematic view illustrating an example of a fuel cell according to the embodiment. The fuel cell 1 includes multiple unit cells 1a stacked on each other, first and second end plates 1b, 1c disposed on both sides of the multiple unit cells 1a, a gas supply passage 1d that extends in the stacking direction of the unit cells and through which gas is supplied to each unit cell 1a, and a gas discharge passage 1e that extends generally in parallel with the gas supply passage 1d and through which the gas discharged from each unit cell 1a flows. The first end plate 1b includes an inlet 1f of the gas supply passage 1d and an outlet 1g of the gas discharge passage 1e.

The fuel cell 1 generates electric energy by electrochemical reaction between hydrogen gas supplied from the high-pressure hydrogen tank 2 and oxidizing gas supplied through the oxidizing gas supply passage 24. Anode off-gas, including the residual hydrogen gas, which is not used in the electricity generation process, and nitrogen gas that is transmitted via the electrolyte membrane of the fuel cell, is discharged from the anode (fuel pole) side of the fuel cell 1 via the anode off-gas passage 22.

The anode off-gas passage 22 is communicably connected with the gas discharge passage 1e in the fuel cell 1, and the off-gas discharged from each unit cell 1a flows through the anode off-gas passage 22. The discharge flow volume of the anode off-gas is controlled by opening and closing the outlet valve 9, which is provided in the anode off-gas passage 22. The fuel cell system 10 of the embodiment performs the electricity generation process of the fuel cell 1 while the discharge of the anode off-gas is stopped (i.e., the outlet valve 9 is closed), thereby reducing the amount of the hydrogen gas discharged from the fuel cell 1.

The hydrogen concentration sensor 4 is disposed in the gas discharge passage 1e of the fuel cell 1 in the vicinity of the second end plate 1c, and detects a hydrogen concentration in the gas discharged from the unit cells 1a. The hydrogen concentration detected by the hydrogen concentration sensor 4 is input to the ECU 5. Based on the detected hydrogen concentration, the ECU 5 controls the supply of hydrogen gas at the start-up of the fuel cell 1, and controls the discharge flow volume of the anode off-gas during the electricity generation process of the fuel cell 1.

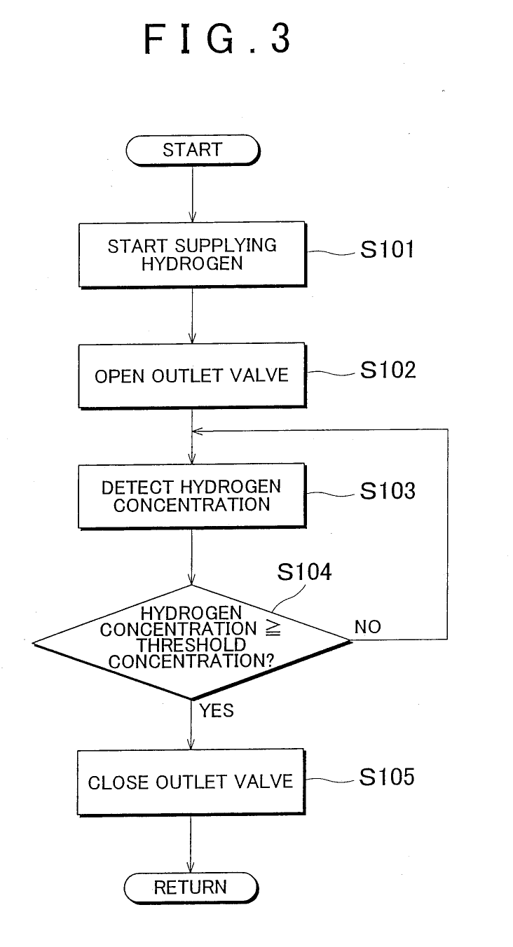

Each control process will be explained in detail with reference to flowcharts below. The control process is a routine executed by the ECU 5. First, the control of the supply of hydrogen gas at the start-up of the fuel cell 1 will be explained with reference to the flowchart shown in FIG. 3.

When the fuel cell is started, hydrogen gas is supplied to the fuel cell 1 to start the electricity generation process (S101). The hydrogen gas supplied to the fuel cell 1 is supplied to each unit cell 1a through the gas supply passage 1d. Next, the ECU 5 opens the discharge valve 9 of the anode off-gas passage 22 (S102). In each unit cell 1a, as the hydrogen gas is supplied, the nitrogen gas that is cross-leaked (i.e., transmitted from cathode to anode through the electrolyte membrane) and accumulated while the electricity generation is stopped is discharged from the fuel cell 1 through the gas discharge passage 1e.

Then, the ECU 5 detects the hydrogen concentration using the hydrogen concentration sensor 4 (S103). The hydrogen concentration sensor 4 is located in the gas discharge passage 1e near the unit cell that is the most distant from the inlet 1f, i.e. is in the vicinity of the second end plate 1c. Because the unit cell 1a in the vicinity of the second end plate 1e is the most distant from the inlet 1f, it is expected that, the particular unit cell is the slowest to fill with hydrogen. Hereinafter, the process in which the gas in the unit cell is replaced with hydrogen (i.e., the process to fill the unit cell with hydrogen) is called a hydrogen replacement process. Accordingly, by detecting the hydrogen concentration at the location, it can be determined whether the hydrogen replacement process is complete in all the unit cells.

The ECU 5 determines whether the detected hydrogen concentration is equal to or higher than a threshold concentration (S104). The threshold concentration is the concentration of hydrogen that indicates completion of hydrogen replacement process. If it is determined in step S104 that the detected hydrogen concentration is lower than the threshold concentration, that is, the hydrogen replacement process is not complete, the anode off-gas continues to be discharged and the hydrogen concentration is detected again after a predetermined period elapses (S103). On the other hand, if it is determined in step S104 that the detected hydrogen concentration is equal to or higher than the threshold concentration, that is, the hydrogen replacement process is completed, the outlet valve 9 is closed (S105). The electricity generation process is performed thereafter.

According to the process described above, it is more accurately determined whether the hydrogen replacement process is completed in the unit cell 1a where the hydrogen replacement process is completed last. Therefore, discharge of the off-gas stops when the hydrogen replacement process is completed in all the unit cells, thereby reducing unnecessary discharge of hydrogen gas.

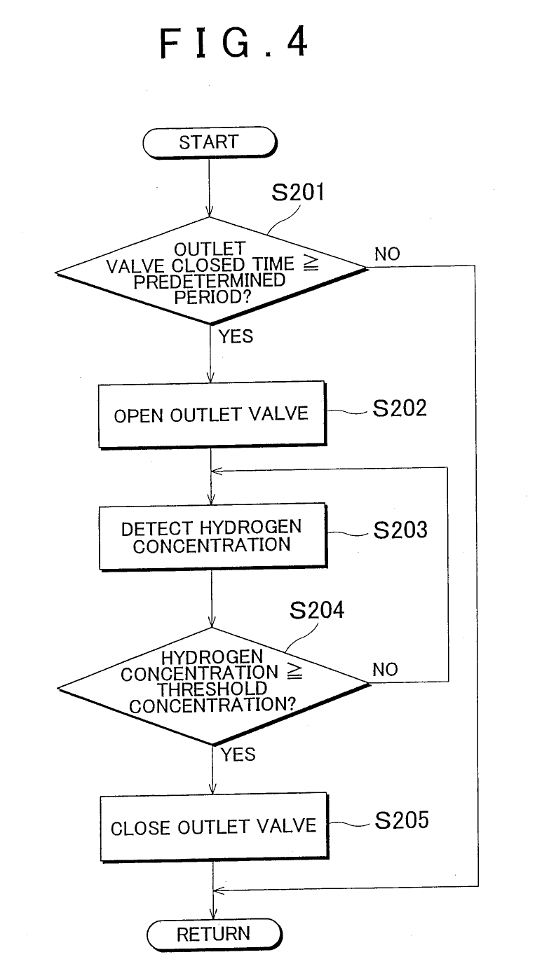

Next, the control process of discharge flow volume of anode off-gas during an electricity generation process is explained with reference to the flowchart shown in FIG. 4. The ECU 5 executes the control process repeatedly at prescribed intervals.

The fuel cell system 10 according to the embodiment performs the electricity generation process of the fuel cell 1 with the outlet valve 9 closed (i.e., without discharging anode off-gas). Further, when the hydrogen concentration is decreased to or below the threshold concentration due to the nitrogen gas transmitted from the cathode side to the anode side, the fuel cell system 10 of the embodiment opens the outlet valve 9 to discharge the nitrogen gas to the exterior of the system.

First, the ECU 5 performs the electricity generation process with the outlet valve 9 closed, and determines whether the outlet valve 9 is closed for a period equal to or longer than a predetermined period (S201). The predetermined period is set in advance based on the temperature, etc. of the fuel cell. If it is determined that the outlet valve 9 is closed for the period equal to or longer than the predetermined period, the outlet valve 9 is opened to discharge the anode off-gas (S202). Thus, the cross-leaked nitrogen gas is discharged to the exterior of the fuel cell 1. Alternative to step S201, the hydrogen concentration sensor 4 may detect the hydrogen concentration while the outlet valve 9 is closed, and the hydrogen concentration detected by the hydrogen concentration sensor 4 may be compared with a threshold concentration to determine whether the outlet valve 9 is opened. For example, the outlet valve 9 may be opened if the hydrogen concentration detected by the hydrogen concentration sensor is lower than the threshold concentration.

Next, the ECU 5 detects the hydrogen concentration using the hydrogen concentration sensor 4 (S203). By detecting the hydrogen concentration using the hydrogen concentration sensor 4, it is determined whether the discharge of the cross-leaked nitrogen gas is finished, thereby enabling the detection of the time to stop discharging anode off-gas (i.e. the time to close the outlet valve). The ECU 5 then determines whether the detected hydrogen concentration is equal to or higher than the threshold concentration (S204). The threshold concentration is a concentration to determine whether the discharge of nitrogen gas is finished. The threshold concentration may be regarded as a maximum threshold limit.

If it is determined in step S204 that the detected hydrogen concentration is lower than the threshold concentration, that is, the discharge of the nitrogen gas is not finished, the anode off-gas continues to be discharged and the hydrogen concentration is detected again after a predetermined period elapses (S203). If it is determined in step S204 that the detected hydrogen concentration is equal to or higher than the threshold concentration, that is, the discharge of the nitrogen gas is finished, the outlet valve is closed (S205). The above process is repeated thereafter.

According to the process described above, the amount of nitrogen gas that is discharged from the unit cell 1a that is furthest from the inlet 1f is determined. Therefore, the outlet valve 9 can be closed at the most appropriate time by determining whether the discharge of the nitrogen gas is finished, thereby reducing the unnecessary discharge of the hydrogen gas.

In the above-described control process for discharging anode off-gas, the discharge flow volume of the anode off-gas is controlled by opening and closing the outlet valve 9, i.e., by starting and stopping discharging the anode off-gas. However, the discharge flow volume of the anode off-gas may alternatively be controlled by continuously discharging the anode off-gas with the discharge flow volume increased or decreased based on the hydrogen concentration in the fuel cell 1.

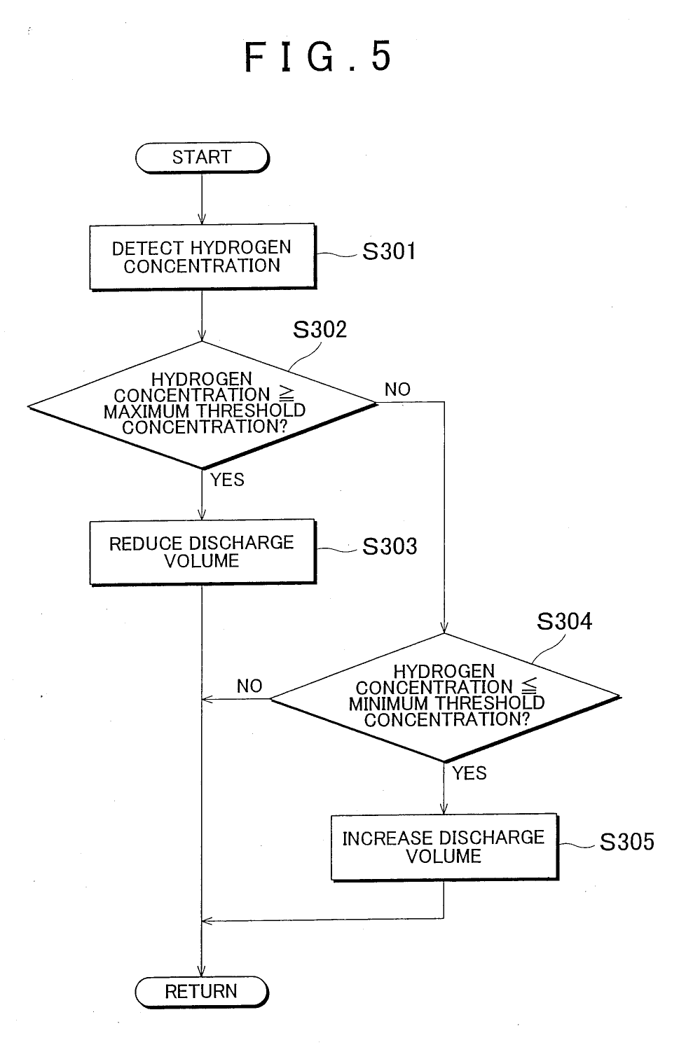

An example of control process for discharging anode off-gas according to a second embodiment is described below with reference to the flowchart shown in FIG. 5. The ECU 5 repeatedly executes this control process at predetermined intervals as well.

During the electricity generation process in the fuel cell 1, the ECU 5 detects the hydrogen concentration using the hydrogen concentration sensor 4 (S301). By doing this, because the anode-off gas is discharged at a constant amount during the electricity generation process, the condition (amount) of nitrogen gas in the discharged anode-off gas can be obtained.

Next, the ECU 5 determines whether the detected hydrogen concentration is equal to or higher than a maximum threshold concentration (S302). The maximum threshold concentration is concentration of hydrogen that is considered sufficient for the electricity generation process, and also is the hydrogen concentration at which hydrogen gas would be unnecessarily discharged with the anode off-gas if the discharge of anode off-gas continues when the detected hydrogen concentration is equal to or higher than the maximum threshold concentration.

If it is determined in step S302 that the detected hydrogen concentration is equal to or higher than the maximum threshold concentration, the outlet valve 9 is adjusted to reduce the discharge flow volume of the anode off-gas, i.e., to reduce unnecessary discharge of hydrogen gas (S303). By doing this, the discharge flow volume of the hydrogen gas included in the anode-off gas is reduced, thereby reducing unnecessary discharge of hydrogen gas.

On the other hand, if it is determined in step S302 that the detected hydrogen concentration is lower than the maximum threshold concentration, it is then determined whether the detected hydrogen concentration is equal to or lower than a minimum threshold concentration (S304). The minimum threshold concentration is the hydrogen concentration that is considered too low for the electricity generation process. If the detected hydrogen concentration is equal to or lower than the minimum threshold concentration, the outlet valve 9 is adjusted to increase the discharge flow volume of the anode off-gas (S305). Further, as the result of the determination in step S304, if the detected hydrogen concentration is higher than the minimum threshold concentration, the discharge flow volume of the anode off-gas is unchanged and this control process ends.

As described above, by controlling the discharge flow volume of the anode off-gas in accordance with hydrogen concentration, the electricity generation process can be performed while reducing unnecessary discharge of hydrogen gas and continuously discharging the anode off-gas.

According to the embodiment described above, unnecessary discharge of hydrogen gas is reduced at the time of start-up or during the electricity generation process. In the first embodiment, the fuel cell system performs the electricity generation process while the discharge of the anode off-gas is stopped. However, the present invention is not limited to this. The fuel cell system may recirculate the anode off-gas to the fuel cell, or, may generate electricity while continuously discharging the anode off-gas at a constant flow volume, instead of recirculating the anode-off gas.

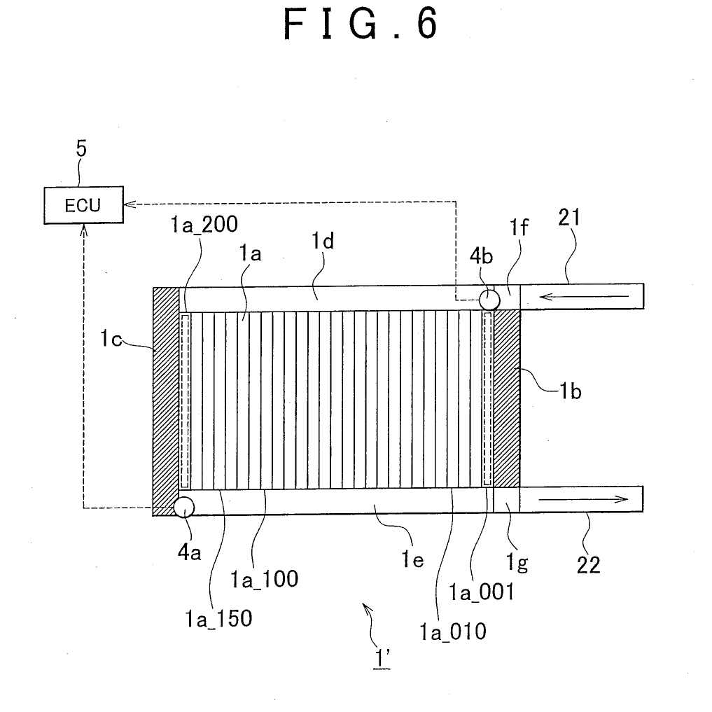

A fuel cell system according to a third embodiment of the present invention is described with reference to FIGS. 6 to 8. FIG. 6 is a view illustrating an example of a fuel cell, etc., according to the third embodiment. The same components as those of the first embodiment are denoted by the same reference numerals. The detailed description thereof will be omitted below.

Similar to the fuel cell 1 in the first embodiment, the fuel cell 1′ shown in FIG. 6 includes multiple unit cells 1a stacked on each other. The inlet 1f, which connects the hydrogen supply passage 21 to the gas supply passage 1d, and the outlet 1g, which connects the anode off-gas passage 22 to the gas discharge passage 1e, are provided on the side of the first end plate 1b. Here, the stack in the fuel cell 1′ includes two hundred (200) unit cells 1a stacked on each other, and the unit cells are denoted 1a_001, 1a_002, . . . , 1a_200 from the side of the first end plate 1b to the side of the second end plate 1c. The unit cells may also referred to as the 1st cell, 2nd cell, . . . , 200th cell, respectively. In FIG. 6, only the unit cells 1a_001, 1a_010, 1a_100, 1a_150 and 1a_200 are illustrated.

Further, the fuel cell 1′ includes a hydrogen concentration sensor 4a in the gas discharge passage 1e, and a hydrogen concentration sensor 4b in the gas supply passage 1d. The hydrogen concentration sensor 4a is located where the concentration of the hydrogen gas discharged from the unit cell 1a_200 may be detected. The hydrogen concentration sensor 4b is located where the concentration of the hydrogen gas supplied to the unit cell 1a_001 may be detected. In particular, the hydrogen concentration sensor 4a is located at the bottom of the gas discharge passage 1e, and the hydrogen concentration sensor 4b is located near the inlet 1f of the gas supply passage 1d.

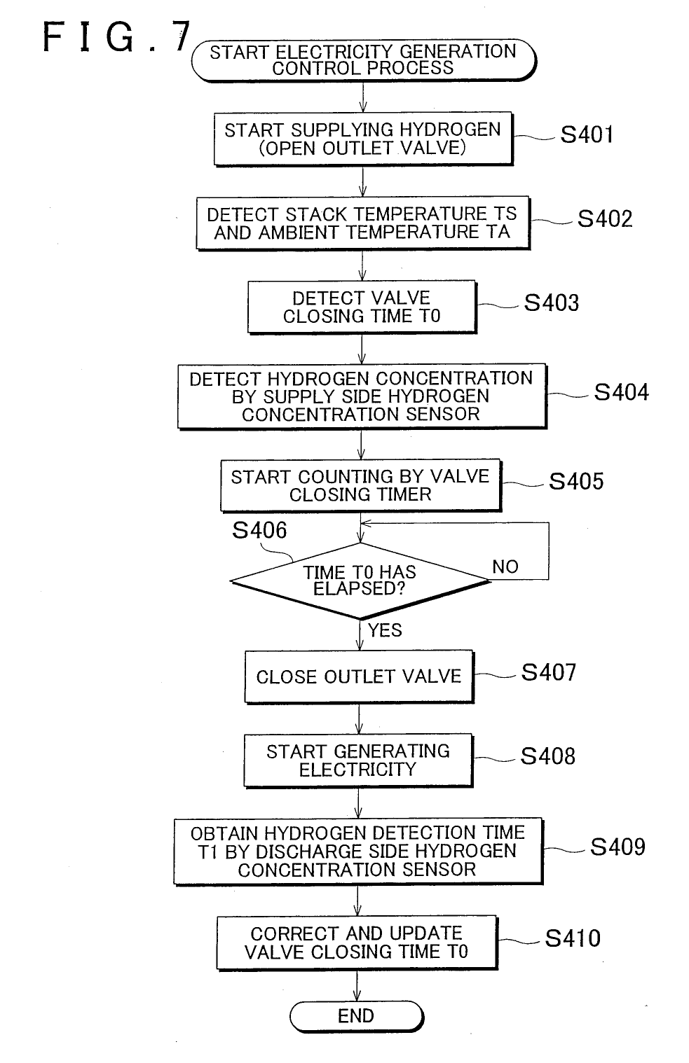

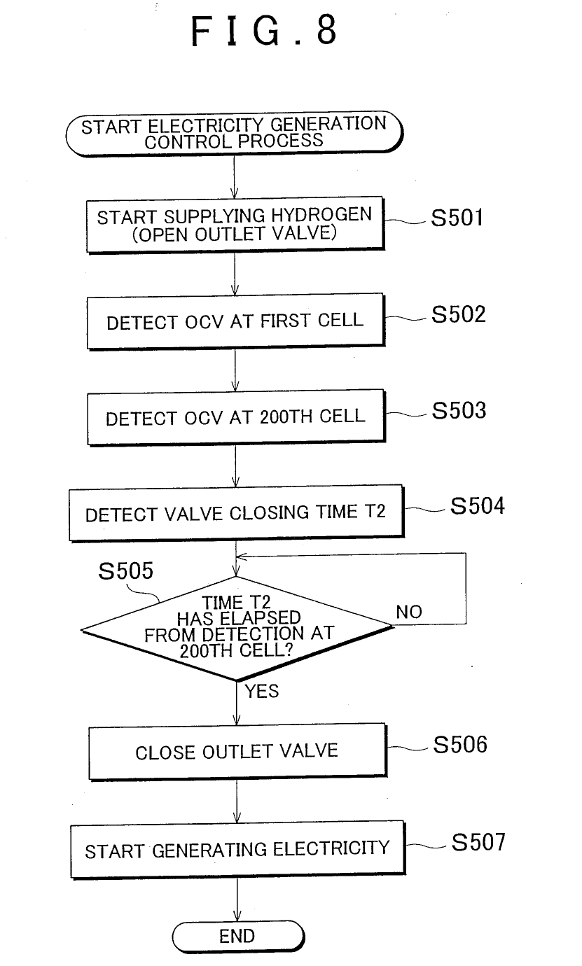

In the fuel cell system including the fuel cell 1′ constructed as described above, the electricity generation control processes shown in FIGS. 7 and 8 are performed. The ECU 5 performs the electricity generation control processes. First, the electricity generation control process shown in FIG. 7 is described. The electricity generation control process is performed when the fuel cell 1′ starts generating electricity. Therefore, the fuel cell 1′ is essentially not generating electricity at the start-up of the electricity generation control process. In other words, when the hydrogen concentration sensors 4a and 4b detect hydrogen gas, this electricity generation control process is not performed.

In step S401, the open valve 6 is opened to start supplying hydrogen gas from the high-pressure hydrogen tank 2 to the fuel cell 1′. At the same time, the outlet valve 9 is opened, and the nitrogen gas cross-leaked when the electricity generation is not performed is discharged from the fuel cell 1′ via the gas discharge passage 1e. This step is the same as that of the first embodiment. After the process in step S401 ends, the control proceeds to step S402.

In step S402, the stack temperature TS, which is the temperature of the fuel cell stack in fuel cell 1′, and the ambient temperature TA, which is the temperature outside the fuel cell system are determined. More specifically, temperature sensors, which are not shown in FIG. 6, respectively detect the temperatures TS and TA. The ECU 5 obtains the detected temperatures. After the process in step S402, the control proceeds to step S403.

In step S403, the valve closing time T0 of the outlet valve 9 at the start-up of the fuel cell 1′, is calculated in accordance with the stack temperature TS and the ambient temperature TA. More specifically, the ECU 5 accesses a map stored in the ECU 5 using the stack temperature TS and the ambient temperature TA as parameters, and calculates the optimal valve closing time T0 determined based on both temperatures. The valve closing time T0 is the time necessary to supply sufficient hydrogen gas to discharge the nitrogen gas from the fuel cell 1′, and to resume a good generating efficiency of the fuel cell 1′. The valve closing time T0 is also the time when the outlet valve 9 is closed to avoid the unnecessary discharge of the hydrogen gas to the exterior of the fuel cell 1′. Further, gas, such as hydrogen gas and nitrogen gas, expands and shrinks depending on the temperature. In other words, the behavior of the gas in the fuel cell 1′ is influenced by the temperature. Therefore, in consideration of such influences, the valve closing time T0 is stored in the map in the ECU 5 in association with the stack temperature TS and the ambient temperature TA. The valve closing time stored in the map will be corrected and updated in step S410 described below. After the process in step S403 ends, the control proceeds to step S404.

In step S404, the hydrogen concentration sensor 4b in the gas supply passage detects hydrogen, and triggered thereby, in step S405, the valve closing timer starts counting to determine the time to close the outlet valve 9. Then, the control proceeds to step S406.

In step S406, it is determined whether the time counted by the valve closing timer reaches the valve closing time T0 calculated in step S403. If it is determined that the counted time reaches the valve closing time T0, the control proceeds to step S407. If it is determined that the counted time does not reach the valve closing time T0, then the process in step S406 is repeated.

In step S407, the outlet valve 9 is closed when the valve closing time T0 elapses. Then, the fuel cell 1′ starts generating electricity in step S408. In this condition at the start-up of electricity generation, each unit cell 1a in the fuel cell 1′ has discharged the cross-leaked nitrogen gas once the valve closing time T0 has elapsed. Accordingly, efficient electricity generation is expected. However, it is not desirable to have the valve closing time T0 be too short, which may occur due to various factors, because the electricity generation starts before the generating efficiency of the fuel cell 1′ is resumed. On the other hand, a valve closing time T0 that is too long is also undesirable because, while the generating efficiency is resumed sufficiently, more hydrogen gas is discharged than necessary. The hydrogen gas could otherwise have been used to generate electricity. Accordingly, in the electricity generating control process according to this embodiment, the valve closing time T0 is corrected in steps S409 and S410 to set a more appropriate length of time for the valve closing time T0.

In step S409, the ECU 5 obtains a hydrogen detection time T1, which is the time at which the hydrogen concentration sensor 4a in the gas discharge passage detects hydrogen gas in the period from the above-described steps S405 to S408. The detection time T1 is the time that has elapsed from when the valve closing timer starts counting, and thus corresponds to the time interval between when the two hydrogen concentration sensors 4a, 4b detect hydrogen gas. If the hydrogen concentration sensor 4a does not detect hydrogen gas during the period, the ECU 5 obtains a signal indicating “no detection” temporarily. After the process in step S409 ends, the control proceeds to step S410.

In step S410, the valve closing time T0 is corrected in accordance with the detection time T1, which was detected in step S409. First, if the detection time T1 is detected, that is, the valve closing time T0 is longer than an optimal value, unnecessary hydrogen gas may be discharged. Therefore, the difference ΔS between when the outlet valve 9 is expected to be closed and is actually closed, is calculated according to the following expression (1).

ΔS=(T0+ΔT)−T1 (1)

Here, ΔT is a difference between when the ECU 5 outputs a valve closing signal to the outlet valve 9 in step S407 and when the outlet valve 9 is actually closed. This difference occurs due to, for example, the time necessary for the valve closing mechanism in the outlet valve 9 to operate.

Then, a new corrected valve closing time T0 is calculated based on ΔS, according to the following expression (2).

(New T0)=T0−B×ΔS(B<1.0) (2)

Here, B is a correction coefficient that is less than 1. In this embodiment, B is set about 0.9. Using the expression (2), the new valve closing time T0 is calculated in consideration of the difference ΔS in the valve closing time of the outlet valve 9. The calculated new valve closing time T0 is stored in association with the stack temperature TS and the ambient temperature TA in the above-described map. Thus, the valve closing time T0 in the map is updated. When the map is updated, only the valve closing time in the map corresponding to the stack temperature TS and ambient temperature TA used in the current control process is updated. Alternatively, the valve closing times corresponding to the other stack temperature TS and ambient temperature TA may be updated as well, in consideration of the difference between corresponding temperatures and the temperatures used in current control process.

Next, if the detection time T1 is not detected, that is, the valve closing time T0 is shorter than the optimal value, insufficient nitrogen gas is discharged from the fuel cell 1′. Therefore, an estimated detection time T10 is calculated according to the following expression (3).

T10=A1×T0+ΔT(A1>1.0) (3)

ΔT is, as describe above, a difference in valve closing time of the outlet valve. A1 is a detection coefficient to calculate the estimated detection time, and is greater than 1. In this embodiment, the detection coefficient A1 may be set around from 1.1 to 1.2. The new valve closing time T0 is calculated by assigning the estimated detection time T10 calculated according to the expression (3) to T1 in the above-described expression (1), and by using the expression (2). In this case, similar to the above, the map in the ECU 5 is updated.

According to this control process, because a more appropriate valve closing time is calculated, both the reduction of unnecessary discharge of the hydrogen gas at the start-up of the fuel cell 1′ and the resumption of generating efficiency of the fuel cell 1′ can be achieved.

Next, the electricity generation control process shown in FIG. 8 is described. Similar to the electricity generation control process shown in FIG. 7, the electricity generation control process is executed at the start-up of the fuel cell 1′. Therefore, the fuel cell 1′ is essentially not generating electricity when the electricity generation control process starts. Accordingly, when the hydrogen concentration sensors 4a, 4b detect the existence of the hydrogen gas, this control process is not executed. Further, in the fuel cell 1′ shown in FIG. 6, with which the present control process is executed, the unit cell 1a_001 and the unit cell 1a_200 are connected to voltmeters, thereby enabling the ECU 5 to detect electromotive force generated by (voltage of) the unit cells, respectively. When using the electricity generation control process shown in FIG. 8, hydrogen concentration sensors 4a, 4b are optional.

In step S501, similar to the above-described step S401, the outlet valve 9 is opened as the hydrogen gas is supplied. Then, the control proceeds to step S502 in which an OCV (open circuit voltage (OCV)) is detected at the first cell. This is because the local electricity generating reaction occurs at the first cell, which is adjacent to the inlet 1f, as a result of the supply of hydrogen gas to the fuel cell 1′ in step S501. After the process in step S502 ends, the control proceeds to step S503.

In step S503, the OCV is detected for the 200th cell. This is because the local electricity generating reaction occurs at the 200th cell when the hydrogen gas, the supply of which is started in step S501, reaches the 200th cell, located at the bottom of the fuel cell 1′. After the process in step S503 ends, the control proceeds to step S504.

In step S504, the valve closing time T2 that determines the time to close the outlet valve 9 is calculated according to the following expression (4), using the time interval TD between when the OCV is detected at the first cell in step S502 and when the OCV is detected at the 200th cell in step S503.

T2=C×TD (4)

The above-described C is a coefficient used to calculate the valve closing time T2. The valve closing time T2 is the time necessary to continue supplying hydrogen gas to start the fuel cell 1′ from when hydrogen gas is detected in the gas discharged from the 200th cell. Therefore, the valve closing time T2 is determined appropriately in consideration of the size of the fuel cell 1′, the location of the 200th cell, and so on. In this embodiment, because the 200th cell is a unit cell located at the bottom of the fuel cell 1′, it can be determined that sufficient hydrogen gas is supplied to start electricity generation in the fuel cell 1′ when the hydrogen gas is detected at the 200th cell. Accordingly, the coefficient C can be set relatively small value. After the process in step S504 ends, the control proceeds to step S505.

In step S505, it is determined whether the valve closing time T2 has elapsed from the detection at the 200th cell in step S503. If it is determined that the time T2 has elapsed, the control proceeds to step S506. If it is determined that the time T2 has not elapsed, the process in step S505 is repeated. In step S506, the outlet valve 9 is closed once the valve closing time T2 has elapsed. Then, in step S507, the fuel cell 1′ starts electricity generation. In this condition at the start-up of the fuel cell, because the valve closing time T2 has elapsed, the nitrogen gas cross-leaked in each unit cell 1a of the fuel cell 1′ is discharged. Therefore, electricity can be generated efficiently. Further, in this control process, unlike the control process shown in FIG. 7, a hydrogen concentration sensor is not used, thereby enabling the reduction of cost to construct the fuel cell system.

Further, according to the embodiment, an OCV is detected at the first and 200th cells; however, it is not necessary to use the OCV at the two cells respectively located at the entrance and bottom of the fuel cell 1′. For example, any two separate unit cells, such as the 150th cell and the 200th cell, the 10th cell and the 100th cell, or the 10th cell and the 150th cell, can be used without departing from the spirit and scope of the invention. In such cases, the coefficient C must be set adequately to calculate an appropriate valve closing time T2 based on the time interval TD between when the OCVs are detected at these two unit cells. For example, if the time interval between the time points of detection of OCV at the 10th cell and the 100th cell are used, because some amount of time is expected for the hydrogen gas to reach from the 100th cell to the 200th cell, which is located at the bottom of the fuel cell, the coefficient C is set larger than the above-described value.

In addition, two unit cells may be chosen so that the time interval TD between when the OCVs are detected at these two unit cells is relatively large. This is because the time of detecting OCV of each unit cell is highly influenced by the flow of hydrogen gas, and the time interval TD varies in some degree even in the same condition with respect to the ambient temperature or stack temperature. Accordingly, to reduce such influences as much as possible, it is preferable to choose two unit cells so that the time interval TD between the two unit cells is no less than 0.1 second.

While some embodiments of the invention have been illustrated above, it is to be understood that the invention is not limited to details of the illustrated embodiments, but may be embodied with various changes, modifications or improvements, which may occur to those skilled in the art, without departing from the spirit and scope of the invention.

1. (canceled)

2. The fuel cell system according to claim 21, wherein the hydrogen concentration sensor is located in a vicinity of the second end plate.

3. The fuel cell system according to claim 21, wherein the controller starts the electricity generation process when the hydrogen concentration detected by the hydrogen concentration sensor is equal to or higher than a threshold concentration after the hydrogen supply device starts supplying the hydrogen gas to the fuel cell.

4. The fuel cell system according to claim 21, further comprising:
an off-gas passage through which off-gas discharged from the fuel cell via the gas discharge passage flows; and
an off-gas flow volume adjustment device, disposed in the off-gas passage, that adjusts a flow volume of the off-gas,
wherein the controller controls the off-gas flow volume adjustment device to adjust the flow volume in accordance with the hydrogen concentration detected by the hydrogen concentration sensor.

5. The fuel cell system according to claim 4, wherein the fuel cell generates electricity when the off-gas flow volume adjustment device prohibits the discharge of off-gas from the fuel cell through the off-gas passage and when the off-gas discharged from the outlet of the gas discharge passage does not recirculate to the fuel cell via the inlet of the gas supply passage, and
wherein the controller determines whether the off-gas flow volume adjustment device continues to prohibit the discharge of the off-gas from the fuel cell or starts discharging the off-gas in accordance with the hydrogen concentration detected by the hydrogen concentration sensor.

6. The fuel cell system according to claim 4, wherein the controller controls the off-gas flow volume adjustment device to increase the discharge flow volume of the off-gas above a reference discharge flow volume, when the hydrogen concentration detected by the hydrogen concentration sensor is equal to or lower than a minimum threshold limit.

7. The fuel cell system according to claim 4, wherein the controller controls the off-gas flow volume adjustment device to decrease the discharge flow volume of the off-gas below a reference discharge flow volume, when the hydrogen concentration detected by the hydrogen concentration sensor is equal to or higher than a maximum threshold limit.

8. The fuel cell system according to claim 4, wherein the controller controls the off-gas flow volume adjustment device to prohibit the discharge of the off-gas, when the hydrogen concentration detected by the hydrogen concentration sensor is equal to or higher than a maximum threshold limit.

9. (canceled)

10. The fuel cell system according to claim 22, wherein the second hydrogen concentration detector is disposed in a vicinity of the first end plate in the gas supply passage.

11. The fuel cell system according to claim 22, wherein the first hydrogen concentration detector is disposed in a vicinity of the second end plate in the gas discharge passage.

12. The fuel cell system according to claim 22, wherein the second unit cell is located upstream of the first unit cell with respect to the flow of hydrogen flowing in the gas supply passage.

13. The fuel cell system according to claim 22, further comprising an off-gas flow volume adjustment device that adjusts a flow volume of off-gas discharged from the fuel cell,
wherein the electricity generation controller controls the off-gas flow volume adjustment device to stop discharging the off-gas from the fuel cell when a predetermined time has elapsed after the second time point.

14. The fuel cell system according to claim 13, wherein the electricity generation controller comprises a map that stores a closing time in association with a temperature,
wherein the electricity generation controller detects a temperature with respect to the fuel cell system, and determines the predetermined time in accordance with the detected temperature and the closing time stored in the map.

15. The fuel cell system according to claim 14, wherein the electricity generation controller updates the closing time stored in the map in accordance with the time interval between the first time point and the second time point.

16. The fuel cell system according to claim 14, wherein the temperature detected by the electricity generation controller includes a stack temperature in the fuel cell and an ambient temperature of the fuel cell system.

17. The fuel cell system according to claim 22, wherein the first hydrogen concentration detector and the second hydrogen concentration detector respectively detect the hydrogen concentrations with respect to the first and second unit cells in accordance with changes in voltages generated by supplying hydrogen to the first and second unit cells,
wherein the first time point is when the voltage generated in the first unit cell reaches a predetermined reference voltage, and the second time point is when the voltage generated in the second unit cell reaches the predetermined reference voltage, and
wherein the electricity generation controller controls the electricity generation process of the fuel cell in accordance with the time interval between the first time point and the second time point.

18. The fuel cell system according to claim 17, further comprising an off-gas flow volume adjustment device that adjusts a flow volume of off-gas discharged from the fuel cell,
wherein the electricity generation controller calculates a closing time in accordance with the first time point and the second time point and controls the off-gas flow volume adjustment device to stop discharging the off-gas from the fuel cell, when the closing time has elapsed from the first time point.

19. (canceled)

20. (canceled)

21. A fuel cell system comprising:
a fuel cell that comprises
a plurality of unit cells stacked on each other;
first and second end plates between which the plurality of unit cells are interposed;
a gas supply passage, extending in a stacking direction of the plurality of unit cells, that supplies gas to the plurality of unit cells, and has an inlet on the first end plate side; and
a gas discharge passage through which gas discharged from the plurality of unit cells flows and has an outlet on the first end plate side;
a hydrogen supply device that supplies hydrogen gas to the plurality of unit cells in the fuel cell through the gas supply passage;
a hydrogen concentration sensor, disposed in the gas discharge passage, that detects a hydrogen concentration in gas discharged from the plurality of unit cells; and
an electricity generation controller that controls an electricity generation process in the fuel cell based on the hydrogen concentration detected by the hydrogen concentration sensor, when the hydrogen supply device supplies the hydrogen gas.

22. A fuel cell system comprising:
a fuel cell that comprises
a plurality of unit cells stacked on each other;
first and second end plates between which the plurality of unit cells are interposed;
a gas supply passage, extending in a stacking direction of the plurality of unit cells, that supplies gas to each of the plurality of unit cells, and has an inlet on the first end plate side; and
a gas discharge passage through which gas discharged from the plurality of unit cells flows and has an outlet on the first end plate side;
a hydrogen supply device that supplies hydrogen gas to the plurality of unit cells in the fuel cell through the gas supply passage;
a first hydrogen concentration detector that detects a hydrogen concentration in gas which is discharged from a first unit cell in the plurality of unit cells and flows in the gas discharge passage;
a second hydrogen concentration detector that detects a hydrogen concentration in gas flowing in the gas supply passage that is supplied to a second unit cell in the plurality of unit cells; and
an electricity generation controller that controls an electricity generation process of the fuel cell in accordance with a time interval between a first time point and a second time point, wherein the first time point is when the first hydrogen concentration detector detects hydrogen, and the second time point is when the second hydrogen concentration detector detects hydrogen.
